(19) United States
(12) Patent Application Publication
(10) Pub. No.: US 2004/0249646 A1
(43) Pub. Date: Dec. 9, 2004

(54) Travel information packets and their marketing strategy

(76) Inventors: Lillian Nelson, St. George, UT (US); Bryan Lee Pugh, Hurricane, UT (US); John Martin McMahon, St. George, UT (US)

Correspondence Address: Lillian Nelson, Bryan Pugh and John McMahon, Suite G, 765 N. Bluff St., St. George, UT, 84770, US

(21) Appl. No.: 10/456,026

(22) Filed: Jun. 9, 2003

(51) Int. Cl. G06F 17/60

(52) U.S. Cl. 705/1

(57) ABSTRACT

Marketing of Travel Information Packets via existing travel retailers.

### CROSS REFERENCE TO RELATED APPLICATIONS

None

### STATEMENT REGARDING FEDERAL SPONSORED R & D

None

### REFERENCE OF TO SEQUENCE LISTING, A TABLE, OR A COMPUTER PROGRAM LISTING APPENDIX

None

### BACKGROUND OF THE INVENTION

Travel Information Packets will impact the travel and tourism industry. A problem experienced in this arena is the communication of information from small and mid-sized local businesses that provide the bulk of services utilized by visitors to the area. Pamphlets, Television, Radio, Billboards, and word of mouth fall desperately short of filling the need of travelers to get information while in the planning stages of a trip. The Travel Information Packets addresses this issue.

### BRIEF SUMMARY OF INVENTION

Travel Information Packets will address the need to inform Travelers of information on their destinations ahead of time. The Packet will consist of information collections that will provide potential travelers information collections from destinations, and will be provided for every destination in the world. This product will be retailed via existing travel retailers, including internet travel retailers, travel providers and travel agents

### BRIEF DESCRIPTION OF THE DRAWINGS

None

### DETAILED DESCRIPTION

Travel Information Packet will consist of several informational brochures relative to a specific travel destination or area. The brochures will contain information on area attractions; restaurants, hotels, coupons and any additional information in brochure form that an area business affected by area travel would like to provide. The information contained in the packet will be provided by the area attractions, as an advertising venue. The travel retailer will market these packets to the Traveler, primarily, at the time of Travel purchase. This will take place both through Travel Agents and Internet booking engines. The Travel Information Packet will be sent by direct mail to the client from the manufacturers storage facility.

1: The primary claim is the unique marketing plan to market the Travel Information Packets via existing Travel Retailers. The product will be retailed through not only travel agents, but also through the Internet based Travel Retailers. This is, to the best of the Inventors knowledge, a completely new marketing plan for this type of product.
